(19) United States
(12) Patent Application Publication
(10) Pub. No.: US 2025/0383060 A1
(43) Pub. Date: Dec. 18, 2025

(54) LIGHTING DEVICE FOR A MOTOR VEHICLE, IN PARTICULAR A HIGH-DEFINITION HEADLAMP

(71) Applicant: Hella GmbH & Co. KGaA, Lippstadt (DE)

(72) Inventors: Sebastian Gatsios, Arnsberg (DE); Florian Herold, Bielefeld (DE); Dirk Kliebisch, Paderborn (DE); Ingo Möllers, Rietberg (DE); Alexander Schwan, Kamen (DE); Patrick Vogel, Unna (DE)

(21) Appl. No.: 19/302,743

(22) Filed: Aug. 18, 2025

Related U.S. Application Data
(63) Continuation-in-part of application No. 18/745,446, filed on Jun. 17, 2024, now abandoned.

(30) Foreign Application Priority Data
Jun. 20, 2023 (DE) 102023116028.1

(51) Int. Cl. F21S 41/63; F21S 41/143; F21S 41/151; F21S 41/25

(52) U.S. Cl. CPC F21S 41/635; F21S 41/143; F21S 41/151; F21S 41/25

(57) ABSTRACT

A lighting device for a motor vehicle includes an imaging component that has an active surface on which light-emitting diodes or laser diodes are arranged, a projection lens with which the light emitted from the active surface is projected outward from the motor vehicle when the lighting device is in operation, and an adjuster connected to the projection lens. The projection lens includes a lens assembly having one or more lenses, and the adjuster varies the focal length of the projection lens in a continuous manner by generating motion of the lens assembly relative to the imaging component.

### CROSS REFERENCE

This application is a continuation in part of U.S. patent application Ser. No. 18/745,446 to Sebastian Gatsios et al., filed Jun. 17, 2024, which claims priority to German Application No. 10 2023 116028.1, filed Jun. 20, 2023, the entirety which are hereby incorporated by reference.

### FIELD OF THE INVENTION

The present invention relates to a lighting device for a motor vehicle, in particular a high-definition headlamp.

### BACKGROUND OF THE INVENTION

DE 10 2020 100 762 A1 discloses a lighting device of this type. The headlamp described therein comprises a first module and a second module. Each module contains a solid-state LED array forming an imaging component with an active surface on which the light-emitting diodes or laser diodes are arranged in a matrix with which pixels are generated in a light distribution in a targeted manner. Each module also has a projection lens with which the light emitted from the active surface is projected outward from the motor vehicle. The light distribution generated by the first module has a higher resolution than that generated by the second module. Both modules can be used, however, to generate a high beam and a symbol projected onto the road surface. Nevertheless, only the first module generates a high-definition symbol.

### BRIEF SUMMARY OF THE INVENTION

The problem addressed by the present invention is to create a lighting device of the above type, with which different light distributions with different resolutions can be generated with a simple design and/or more cost-effectively.

Such a lighting device is designed such that the focal length of the projection lens can be varied in a continuous manner. The pixel density depends on the focal length of the projection lens. This means that there is no need for the two different modules used in the prior art to obtain different resolutions, thus resulting in a simpler and/or less expensive lighting device.

The imaging component can be a solid-state LED array, in particular an SSL-HD module.

The lighting device can have an adjuster for adjusting the focal length of the projection lens. The adjuster can be a motor, in particular a stepper motor. The focal length can be selected with the adjuster to satisfy a specific need.

The projection lens can be or comprise a lens assembly. This can be or comprise a zoom lens.

The lighting device can be designed to adjust the focal length of the projection lens by moving the lens assembly in relation to the active surface of the imaging component.

The projection lens and/or lens assembly can contain numerous lenses, in particular at least three lenses, preferably at least four lenses, through which the light emitted from the active surface of the imaging component passes successively. This lighting device can be designed such that at least two of the lenses can be moved in relation to one another in order to adjust the focal length of the projection lens.

The lighting device can contain a device for refocusing, such that the projection can be brought back into focus after changing the focal length of the projection lens. This refocusing can be obtained by changing the positions of the individual lenses. Refocusing is particularly advantageous if changing the focal length of the projection lens is obtained by moving the lens in relation to the active surface of the imaging component.

The lighting device can be designed to switch back and forth between different fields of view by changing the focal length of the projection lens. The first field of view can have a first image angle, and the second can have a second image angle, which is smaller than the first.

The first field of view can be for a light distribution, and the second can be for a video projection in front of the motor vehicle. By way of example, a large field of view with a low pixel density can be obtained while the vehicle is moving, and a small field of view with a high pixel density can be obtained in a video projection while the vehicle is stationary.

Alternatively, the first field of view can be used for a first mode of the high beam light distribution, and the second field of view can be used for a second mode of the high beam light distribution that differs from the first. By way of example, one of the two high beam modes can be ideal for when there are no obstructions in front of the vehicle, and thus be brighter as a result of it being more focused.

The lighting device may be designed such that when it is shut off, the projection lens is moved to a position in which the field of vision and/or image angle are minimized. Consequently, when the sun is low over the horizon, the solid-state LED array will not be damaged by sunlight passing through the lens.

Because the focal length can be varied continuously, the lighting device can be optimized for more than two different applications. By way of example, there can be numerous different high beam modes as well as a video projection mode, or numerous video projection modes, each of which is different as a result the focal length that is set.

On the whole, the value of the lighting device itself is increased by being able to change the focal length of the projection lens.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a schematic side view of a first exemplary embodiment of the lighting device according to the invention, with an exemplary light beam, in which the projection lens is in a first setting.

FIG. 2 shows a schematic side view of the first exemplary embodiment with the projection lens in a second setting.

FIG. 3 shows a schematic side view of a second exemplary embodiment of the lighting device according to the invention, with an exemplary light beam, in which the projection lens is in a first setting.

FIG. 4 shows a schematic side view of the second exemplary embodiment with the projection lens in a second setting.

### DETAILED DESCRIPTION OF THE DRAWINGS

The same reference symbols are used for identical and functionally identical components in the drawings.

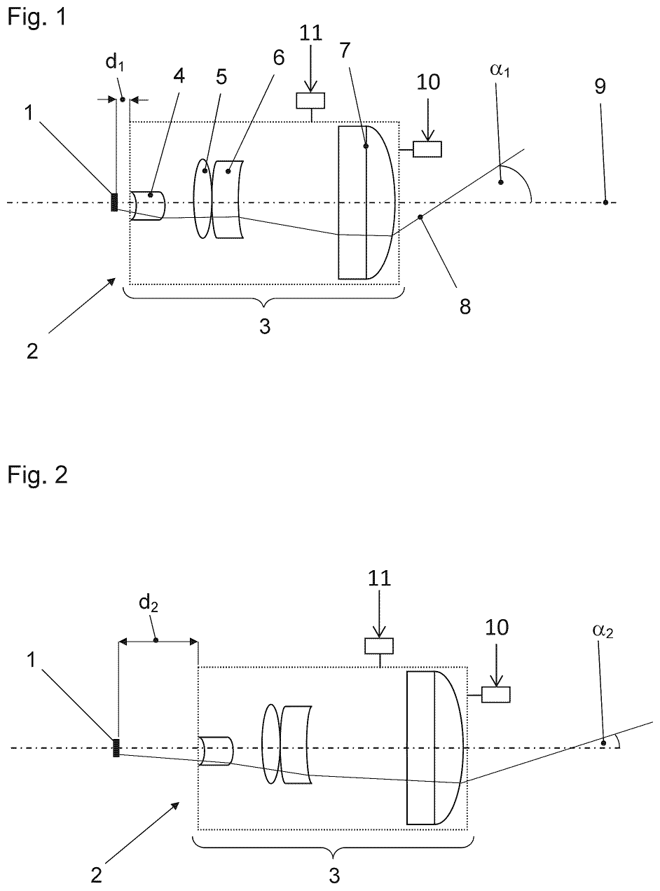

The first exemplary embodiment of the lighting device shown in FIGS. 1 and 2 comprises an imaging component 1 that has an active surface on which light-emitting diodes or laser diodes are arranged in a matrix to generate the pixels in a light distribution in a targeted manner. The imaging component 1 is a solid-state LED array, in particular an SSL-HD module.

The lighting device also contains a projection lens 2. The projection lens 2 may be provided in the form of a lens assembly 3, which may include one or more lenses or lens components. In addition to the lens assembly 3, the projection lens 2 can also contain one or more optical components.

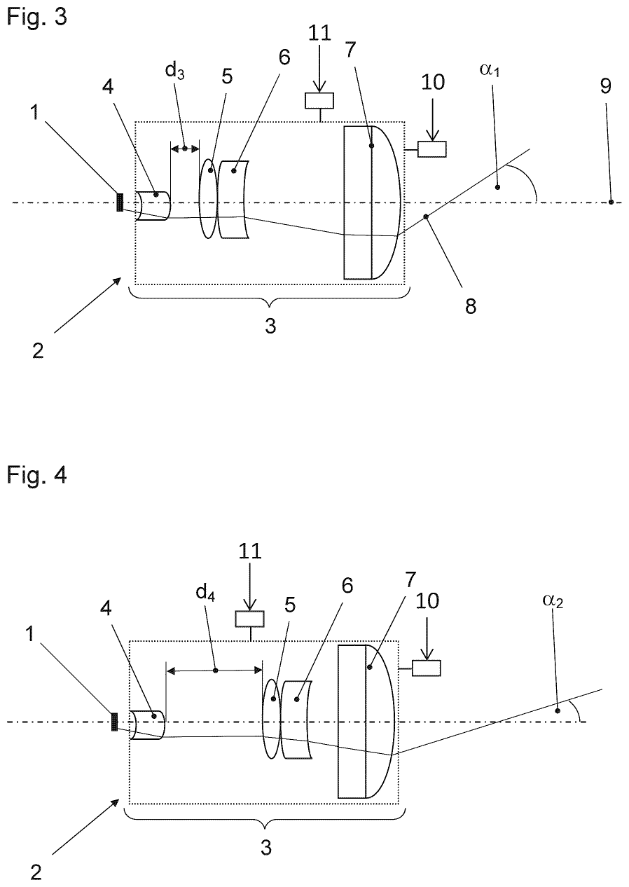

The lens assembly 3 in the exemplary embodiments shown in the drawings contains four lenses including a first lens 4, a second lens 5, a third lens 6, and a fourth lens 7 (collectively referred to hereinafter as “lenses 4, 5, 6, 7”), through which the light 8 emitted from the imaging component 1 passes successively. The optical axis 9 of the lens assembly is also indicated in the drawings. The lens assembly 3 can also contain more or less than four lenses. In particular, in some embodiments, the lens assembly 3 may contain four to seven lenses. The projection lens 2 may be designed to move between at least a first setting (see, e.g., FIG. 1 or FIG. 3) and a second setting (see, e.g., FIG. 2 or FIG. 4), as described in further detail below. For example, the first setting of the projection lens 2 may be associated with a first focal length and/or a first image angle, and the second setting of the projection lens 2 may be associated with a second focal length and/or a second image angle.

As shown in FIG. 1, the lens assembly 3 may be positioned at a first distance d₁ relative to the imaging component 1 when the projection lens 2 is in the first setting. In the first setting, a portion of the light 8 exits the lens assembly 3 at a first image angle α₁ relative to the optical axis 9. For example, the first image angle α₁ may correspond to an image angle for headlamp functions in which the pixels are relatively large and the pixel density is relatively low.

The lighting device may also contain an adjuster 10 with which the focal length of the projection lens 2 may be adjusted. In other words, the adjuster 10 may be configured to cause movement of the projection lens 2 between the first setting and the second setting. For example, the adjuster 10 may be provided in the form of a stepper motor, although the adjuster 10 may also be provided in any other suitable form.

The adjuster 10 may be coupled to the projection lens 2 and may be configured to generate translational motion of the projection lens 2 (or of one or more components thereof) along the optical axis 9 in relation to the imaging component 1. In some embodiments, the adjuster 10 may cause the projection lens 2 to move between the first setting and the second setting by causing the lens assembly 3, as a whole, to move in relation to the active surface of the imaging component 1, thereby adjusting the focal length of the projection lens 2. In other words, the adjuster 10 may be configured to generate collective motion of the lenses 4, 5, 6, 7 as a singular unit. The adjuster can therefore change the distance d₁ between the lens assembly 3 and the imaging component 1.

Additionally, the lighting device may contain a refocusing device 11 configured to bring the projection lens 2 back into focus. For example, the refocusing device 11 may be configured to refocus the projection lens 2 after the adjuster 10 is operated to alter a focal length of the projection lens 2. In some embodiments, the refocusing device 11 may be coupled to the projection lens 2 such that the refocusing device 11 can adjust the configuration or position of one or more components of the projection lens as needed. For example, the refocusing device 11 may be connected to the individual components of the projection lens 2 such as the lenses 4, 5, 6, 7 such that the refocusing device 11 is configured to adjust the position of one or more lenses 4, 5, 6, 7 along the optical axis 9 with respect to one another. The refocusing device 11 may be particularly advantageous when the focal length of the projection lens 2 is adjusted by operating the adjuster 10 to alter the distance between the entire lens assembly 3 and the imaging component 1. Together, the adjuster 10 and refocusing device 11 may enable the lighting device to vary the focal length of the projection lens 2 in a continuous manner.

Thus, as shown in FIG. 2, the lens assembly 3 may be positioned at a second distance d₂ relative to the imaging component 1 when the projection lens 2 is in the second setting. The second distance d₂ may be greater than the first distance d₁. In the second setting, a portion of the light 8 exits the lens assembly 3 at a second image angle α₂ relative to the optical axis 9. The second image angle α₂ may be smaller than the first image angle d₁. The second image angle α₂ may correspond to an image angle for image or video projection in which the pixels are relatively small, and the pixel density is relatively high.

The second exemplary embodiment of the lighting device shown in FIGS. 3 and 4 contains substantially the same components as the first exemplary embodiment shown in FIGS. 1 and 2. However, in the second embodiment, the adjuster 10 may not be not configured to move the lens assembly 3 in relation to the active surface of the imaging component 1. Instead, the adjuster 10 may be configured to generate movement of one or more components of the projection lens 2 relative to one or more other components of the projection lens 2 without altering the distance between the projection lens 2 and the imaging component 1. For example, the adjuster 10 may be configured to cause movement of one or more individual lenses or of one or more groups of lenses in the lens assembly 3 in relation to one or more other lenses or one or more other groups of lenses, to adjust the focal length of the projection lens 2. The adjuster 10 may be connected to each of the lenses 4, 5, 6, 7 of the lens assembly 3 such that the adjuster 10 is configured to cause movement of any one of the lenses 4, 5, 6, 7 or of any combination of one or more of the lenses 4, 5, 6, 7, thereby adjusting the focal length of the projection lens 2. The adjuster 10 of the second embodiment may be provided in the form of a stepper motor, although the adjuster 10 may be provided in any other suitable form.

FIGS. 3 and 4 depict a non-limiting embodiment in which the adjuster 10 is configured to alter the focal length of the projection lens 2 by causing movement of the second and third lenses 5, 6 relative to the first lens 4 and/or relative to the fourth lens 7. However, in other embodiments, the adjuster 10 may alter the focal length of the projection lens 2 by causing movement of any of the lenses 4, 5, 6, 7 or any combination of the lenses 4, 5, 6, 7 relative to any other lens 4, 5, 6, 7 or any other combination of lenses 4, 5, 6, 7. As shown, the adjuster 10 may adjust the position of one or more lenses (e.g., lenses 5, 6) without altering a distance between the projection lens 2 or the lens assembly 3 and the imaging component 1.

As shown in FIG. 3, a third distance d₃ may separate the first lens 4 (e.g., the lens at the entry side of the lens assembly 3 or the lens positioned proximate to the imaging component 1) from the second and third lenses 5, 6 when the projection lens 2 is in the first setting. In the first setting, a portion of the light 8 exits the lens assembly 3 at a first image angle α₁ relative to the optical axis 9. The first image angle α₁ may correspond to an image angle for headlamp functions in which the pixels are relatively large and the pixel density is relatively low.

As shown in FIG. 4, the adjuster may alter the third distance d₃ when the adjuster 10 causes the projection lens 2 to move to the second setting. For example, in the second setting, a fourth distance d₄ may separate the first lens 4 and the second and third lenses 5, 6. The fourth distance d₄ may be greater than the third distance d₃. Thus, in some embodiments, moving the lens assembly 3 from the first setting to the second is achieved by moving the second and third lenses 5, 6 in the lens assembly 3 from left to right in FIGS. 3 and 4. The first lens 4 and the fourth lens 7 may remain stationary.

In the second setting of the second exemplary embodiment, a portion of the light 8 also exits the lens assembly 3 at a second image angle α₂ relative to the optical axis 9. The second image angle α₂ may be smaller than the first image angle α₁. The second image angle α₂ may correspond to an image angle for video projection in which the pixels are relatively small, and the pixel density is relatively high.

Instead of moving the second and third lenses 5, 6 in the lens assembly 3, it is also possible to move another lens or group of lenses in the lens assembly 3 to alter the focal length of the lens assembly 3, or the focal length of the projection lens 2.

### LIST OF REFERENCE SYMBOLS

1 imaging component
2 projection lens
3 lens assembly
4 first lens in the lens assembly
5 second lens in the lens assembly
6 third lens in the lens assembly
7 fourth lens in the lens assembly
8 light emitted from the imaging component
9 optical axis of the lens assembly
α₁ first image angle
α₂ second image angle
d₁ first distance from the lens assembly to the imaging component
d₂ second distance from the lens assembly to the imaging component
d₃ distance between the first and second lenses in the lens assembly in the first setting of the projection lens
d₄ distance between the first and second lenses in the lens assembly in the second setting of the projection lens

1. A lighting device for a motor vehicle, the lighting device comprising:
an imaging component that has an active surface on which light-emitting diodes or laser diodes are arranged;
a projection lens with which the light emitted from the active surface is projected outward from the motor vehicle when the lighting device is in operation, the projection lens comprising a lens assembly including one or more lenses; and
an adjuster connected to the projection lens,
wherein the adjuster varies the focal length of the projection lens in a continuous manner by generating motion of the lens assembly relative to the imaging component.

2. The lighting device according to claim 1, wherein the imaging component is a solid-state LED array.

3. The lighting device according to claim 1, further including a refocusing device configured to refocus the projection lens after the adjuster alters the focal length thereof.

4. The lighting device according to claim 1, wherein the adjuster is a motor.

5. The lighting device according to claim 1, wherein the adjuster is also configured to alter the focal length of the projection lens by generating motion of one or more lenses relative to one or more other lenses while maintaining a distance between the lens assembly and the imaging component.

6. The lighting device according to claim 1, wherein the refocusing device is connected to the one or more lenses of the lens assembly and configured to refocus the projection lens by generating motion of one or more lenses relative to one or more other lenses.

7. The lighting device according to claim 1, wherein the one or more lenses of the lens assembly comprise two or more lenses through which the light emitted from the active surface of the imaging component passes successively when the lighting device is in operation.

8. The lighting device according to claim 7, wherein at least two lenses of the two or more lenses move in relation to one another to adjust the focal length of the projection lens.

9. The lighting device according to claim 1, wherein the adjuster is configured to generate translational motion of either the lens assembly or at least one of the one or more lenses along an optical axis of the lens assembly.

10. The lighting device according to claim 1, wherein the lighting device is designed to switch back and forth between different fields of view by changing the focal length of the projection lens.

11. The lighting device according to claim 10, wherein a first field of view has a first image angle (α₁), and a second field of view has a second image angle (α₂), wherein the second image angle (α₂) is smaller than the first image angle (α₁).

12. The lighting device according to claim 11, wherein the first field of view relates to a headlamp light distribution, and the second field of view relates to a video projection in front of the motor vehicle.

13. The lighting device according to claim 11, wherein the first field of view relates to a first high beam light distribution mode and the second field of view relates to a second high beam light distribution mode that differs from the first high beam light distribution mode.

14. The lighting device according to claim 11, wherein the projection lens moves to a setting with a minimal field of view and/or image angle when the lighting device is shut off.

15. The lighting device according to claim 2, wherein the imaging component is an SSL-HD module.

16. The lighting device according to claim 4, wherein the adjuster is a stepper motor.

17. The lighting device according to claim 7, wherein the two or more lenses comprise at least three lenses.
